(19) United States
(12) Patent Application Publication
(10) Pub. No.: US 2025/0267496 A1
(43) Pub. Date: Aug. 21, 2025

(54) ENHANCED GBBR WITH MRTD REPORTING FOR MTRP

(71) Applicant: Apple Inc., Cupertino, CA (US)

(72) Inventors: Xiang CHEN, Palo Alto, CA (US); Yang TANG, San Jose, CA (US); Jie CUI, San Jose, CA (US); Haitong SUN, Saratoga, CA (US); Qiming LI, Beijing (CN); Manasa RAGHAVAN, Sunnyvale, CA (US); Yuexia SONG, Beijing (CN); Dawei ZHANG, Saratoga, CA (US)

(21) Appl. No.: 19/054,705

(22) Filed: Feb. 14, 2025

Related U.S. Application Data
(60) Provisional application No. 63/554,890, filed on Feb. 16, 2024.

(51) Int. Cl. H04W 24/10; H04B 7/06; H04L 27/26

(52) U.S. Cl. CPC H04W 24/10; H04B 7/06952; H04L 27/2678

(57) ABSTRACT

The techniques described herein may include solutions for enhanced group-based beam reporting (GBBR) with maximum receive timing difference (MRTD) reporting for multiple transmission reception points (mTRPs). One or more of these solutions may include communicating to user equipment (UE) configuration information for GBBR based on UE capability information and MRTD measurements received from UE. One or more of these solutions may also include receiving from a base station configuration information for performing GBBR, and determining and communicating to the base station, a receive timing difference (RTD) using GBBR. Also provided are solutions for structures of enhanced GBBR.

### CROSS REFERENCE TO RELATED APPLICATIONS

This application claims the benefit of U.S. Provisional Application No. 63/554,890, filed Feb. 16, 2024, the content of which is herein incorporated by reference in its entirety for all purposes.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fourth generation (4G), fifth generation (5G) or new radio (NR) technology. Such technology may include solutions for enabling user equipment (UE) and network devices, such as base stations, to communicate with one another. Some scenarios may involve enabling or configuring a UE to communicate with multiple network devices.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example of an overview of a UE in a multi TRP environment according to one or more implementations described herein.

FIG. 2 is a diagram of an example network according to one or more implementations described herein.

FIG. 3 is a diagram of an example of two channel measurement resource (CMR) sets according to one or more implementations described herein.

FIG. 4 is a diagram of an example of enhanced group-based beam reporting (GBBR) with maximum receiving timing difference (MRTD) reporting for multiple transmission reception points (mTRPs) according to one or more implementations described herein.

FIG. 5 is a diagram of an example of a data structure of an example GBBR report according to one or more implementations described herein.

FIG. 6 is a diagram of an example of an example of enhanced GBBR with MRTD reporting for mTRPs according to one or more implementations described herein.

FIG. 7 is a diagram of an example of a representation of a data structure of an example enhanced GBBR report according to one or more implementations described herein.

FIG. 8 is a diagram of an example of a representation of a data structure of an example enhanced GBBR report according to one or more implementations described herein.

FIG. 9 is a diagram of an example of a process for enhanced GBBR with MRTD reporting for mTRPs according to one or more implementations described herein.

FIG. 10 is a diagram of an example of a process for enhanced GBBR with MRTD reporting for mTRPs according to one or more implementations described herein.

FIG. 11 is a diagram of an example of components of a device according to one or more implementations described herein.

FIG. 12 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and/or other network access nodes. UEs and base stations (or transmission reception points (TRPs)) may implement various techniques and communications standards for discovering one another, establishing and maintaining connectivity, exchanging information in an ongoing manner, and more. A TRP, as referred to herein, may refer to a base station, antenna, antenna port, and/or other device capable of transmitting and receiving wireless signals. Scenarios that involve multiple TRPs, therefore, may include a single base station with multiple TRPs, multiple base stations with one or more TRPs, etc. In such scenarios, different possible configurations of TRPs or multiple TRPs may be referred to generally as “network.” Objectives of such techniques may include improving the quality and reliability of signal transmissions during adverse synchronization conditions.

In multi-TRP (mTRP) environments, UEs may receive transmissions simultaneously from multiple TRPs. Each TRP may transmit a plurality of beams, each having a different transmission direction and other characteristics. For a given UE in such an environment, the network may determine a transmission direction for each TRP to ensure optimal reception at the UE. To that end, the network may configure a reporting mechanism for a UE to measure relevant downlink (DL) reception (Rx) parameters and report measurements to the network. In a two-TRP environment, for example, the network may configure channel measurement resource (CMR) sets for each TRP. A CMR, as referred to herein, may refer to a set of resources allocated by the network (e.g., a base station or a TRP) for measuring characteristics of channels between base stations or TRPs and UEs. Characteristics collected may including timing, signal strength, signal to noise ratio, among others. Thus, each CMR set may include resources allocated to reference signals of a base station or TRP. For each CMR set, the corresponding TRP may transmit one or more reference signals (RS), each having a different DL direction. In response, the UE may implement group-based beam reporting (GBBR) to report characteristics of pairs or groups of RS beams (one beam from each TRP) based on measured reference signal received power (RSRP), signal strength, etc. The GBBR may enable the network to select beam pairs for optimal DL Rx at the UE, and thereby provide and/or maintain superior coordinated service.

Existing reporting mechanisms and GBBR structures are often based on RSRP (or similar metrics) and may rely on network conditions where maximum receiving timing difference (MRTD) between beam pairs is less than a corresponding cycle prefix (CP). Receive timing difference (RTD), as referred to herein, may refer to a measure of a difference in the arrival time between signals received at the UE from multiple TRPs during coordinated transmission. The maximum RTD (MRTD), as referred to herein, may refer to a measure of a maximum difference in the arrival time or delay between the signals received at the UE from the multiple TRPs for which coordinated transmission can be maintained. The cycle prefix (CP), as referred to herein, refers to a duration of a buffer region or interval between symbols of a transmitted signal.

When MRTD is less than CP, a UE may operate based on the assumption of good TRP synchronization, which may simplify UE implementation by dispensing with the maintenance of a dedicated time tracking loop for each TRP. However, a MRTD that is less than CP conditions may be challenging to maintain for groups of TRPs due to relative time drifting and propagation delay differences resulting from, for example, frequent changes in a location of the UE relative to each of the TRPs.

One or more of the techniques described herein may address these and other deficiencies by providing solutions for an enhanced GBBR for MRTD reporting when MRTD is less than a CP or when MRTD greater is than CP for multiple TRPs. In particular, the techniques provided herein may include determining whether a UE is capable of supporting a scenario in which MRTD is greater than CP, and if so, configuring the UE to measure MRTD for reporting using GBBR. Accordingly, in some implementations, the network may configure the UE to measure and report MRTD and UE support for MRTD greater than CP by configuring “DL Rx Timing” in a TCI state for RSs. MRTD reporting may be configured for one, some, or all UEs. Based on the received MRTD, a base station may configure GBBRs for UEs that support MRTD greater than CP, enabling UE scheduling based on traditional GBBR reports in the multi-TRP environment when an RTD is greater than CP.

In another implementation, the network may configure the MRTD measurement to an enhanced GBBR according to the present disclosure. The MRTD measurement may be provided with an enhanced GBBR following an existing reporting structure, but that also includes an additional field for reporting the MRTD measurement for each RS beam pair. Alternatively, the enhanced GBBR may be provided as a two-part structure, each duplicating the legacy GBBR reporting structure, with a first part reporting RS beam pairs that support MRTD less than CP and the second part reporting beam pairs that support MRTD greater than CP. The enhanced GBBR featuring indications of timing measurements such as MRTD and related network timing conditions facilitates the scheduling of UEs and the maintenance of coordinated service in multi-TRP environments.

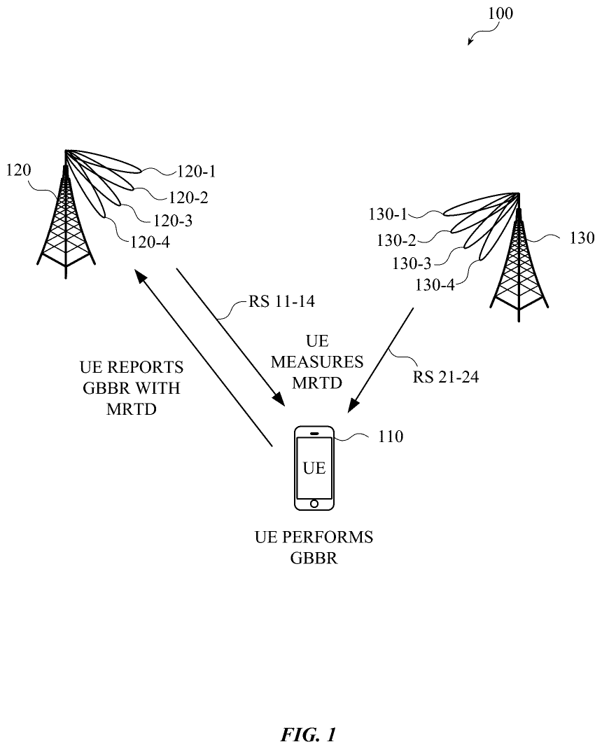

FIG. 1 is a diagram of an example of an overview 100 according to one or more implementations described herein. As shown, overview 100 includes UE 110 and TRPs 120 and 130. TRPs 120 and 130 form a multi-TRP environment in which implementations of the present disclosure may operate. Each TRP may transmit a plurality of beams having different directions. TRP 120 may transmit beams 120-1, 120-2, 120-3, and 120-4 (RSs collectively shown as RS 11-14) and TRP 130 may transmit beams 130-1, 130-2, 130-3, and 130-4 (RS 21-24). It is understood that the number of beams transmitted by each of TRP 120 and 130 is illustrative and that the TRPs may transmit any number of beams.

UE 110 may be configured to simultaneously receive beams transmitted from both TRP 120 and 130. The network (e.g., a base station) may determine a transmission direction (i.e., a beam) for each TRP that ensures optimal reception at UE 110. To that end, the network may configure a reporting mechanism for UE 110 to measure relevant DL Rx parameters and report the measurements to the network. In some implementations, the network may receive from UE 110 reports of UE synchronization capability indicating whether UE 110 can support simultaneous reception from multiple TRPs when MRTD is greater than a corresponding CP. To evaluate network conditions (e.g., whether MRTD is greater or less than CP), the network may configure UE 110 to perform and report to a TRP (e.g., TRP 120) timing measurements including MRTD for TRP 120 and 130. In some implementations, the network may configure UE 110 for GBBR based on the UE capability and the reported timing measurements. Alternatively, such as illustrated in FIG. 1, the network may dispense with measuring MRTD before configuring the UE to perform GBBR, and instead, may configure UE 110 to provide MRTD measurements for beam pairs of the TRPs as part of GBBR. The enhanced GBBR featuring indications of timing measurements such as MRTD and related network timing conditions facilitate the scheduling of UEs and the maintenance of coordinated service in multi-TRP environments.

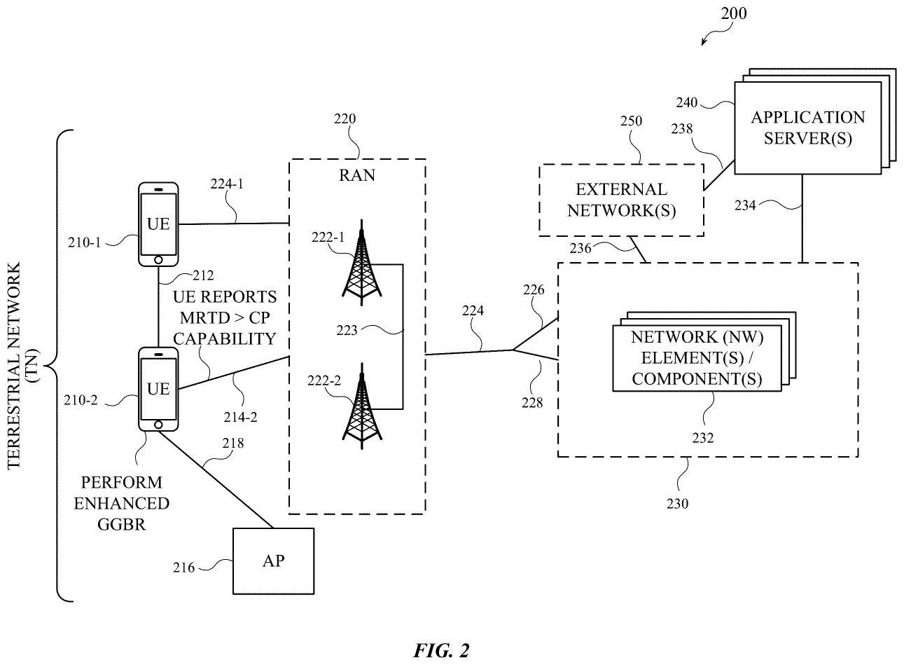

FIG. 2 is an example network 200 according to one or more implementations described herein. Example network 200 may include UEs 210, 210-2, etc. (referred to collectively as “UEs 210” and individually as “UE 210”), a radio access network (RAN) 220, a core network (CN) 230, application servers 240, and external networks 250.

The systems and devices of example network 200 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 may include smartphones (e.g., handheld touchscreen mobile computing devices connectable to one or more wireless communication networks). Additionally, or alternatively, UEs 210 may include other types of mobile or non-mobile computing devices capable of wireless communications, such as personal data assistants (PDAs), pagers, laptop computers, desktop computers, wireless handsets, etc. In some implementations, UEs 210 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 210 may communicate and establish a connection with one or more other UEs 210 via one or more wireless channels 212, each of which may comprise a physical communications interface/layer. The connection may include an M2M connection, MTC connection, D2D connection, SL connection, etc. The connection may involve a PC5 interface. In some implementations, UEs 210 may be configured to discover one another, negotiate wireless resources between one another, and establish connections between one another, without intervention or communications involving RAN node 222 or another type of network node. In some implementations, discovery, authentication, resource negotiation, registration, etc., may involve communications with RAN node 222 or another type of network node.

UEs 210 may use one or more wireless channels 212 to communicate with one another. As described herein, UE 210 may communicate with RAN node 222 to request SL resources. RAN node 222 may respond to the request by providing UE 210 with a dynamic grant (DG) or configured grant (CG) regarding SL resources. A DG may involve a grant based on a grant request from UE 210. A CG may involve a resource grant without a grant request and may be based on a type of service being provided (e.g., services that have strict timing or latency requirements). UE 210 may perform a clear channel assessment (CCA) procedure based on the DG or CG, select SL resources based on the CCA procedure and the DG or CG; and communicate with another UE 210 based on the SL resources. The UE 210 may communicate with RAN node 222 using a licensed frequency band and communicate with the other UE 210 using an unlicensed frequency band.

UEs 210 may communicate and establish a connection with (e.g., be communicatively coupled) with RAN 220, which may involve one or more wireless channels 214-1 and 214-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 222-1 and 222-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 230. Additionally, at least one of the MN or the SN may be operated with shared spectrum channel access, and functions specified for UE 210 can be used for an integrated access and backhaul mobile termination (IAB-MT). Similar for UE 210, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 222.

As described herein, UE 210 may receive and store one or more configurations, instructions, and/or other information for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL channel occupancy time (COT) sharing, maximum (MCOT), timing gaps for COT sharing, LBT configuration, traffic and channel priorities, and more.

As shown, UE 210 may also, or alternatively, connect to access point (AP) 216 via connection interface 218, which may include an air interface enabling UE 210 to communicatively couple with AP 216. AP 216 may comprise a wireless local area network (WLAN), WLAN node, WLAN termination point, etc. The connection 216 may comprise a local wireless connection, such as a connection consistent with any IEEE 702.11 protocol, and AP 216 may comprise a wireless fidelity (Wi-Fi®) router or other AP. While not explicitly depicted in FIG. 2, AP 216 may be connected to another network (e.g., the Internet) without connecting to RAN 220 or CN 230. In some scenarios, UE 210, RAN 220, and AP 216 may be configured to utilize LTE-WLAN aggregation (LWA) techniques or LTE WLAN radio level integration with IPsec tunnel (LWIP) techniques. LWA may involve UE 210 in RRC_CONNECTED being configured by RAN 220 to utilize radio resources of LTE and WLAN. LWIP may involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling may include encapsulating the entirety of original IP packets and adding a new packet header, thereby protecting the original header of the IP packets.

RAN 220 may include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 may include a roadside unit (RSU), a transmission reception point (TRxP or TRP), and one or more other types of ground stations (e.g., terrestrial access points). In some scenarios, RAN node 222 may be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 222; a media access control (MAC)/physical (PHY) layer split wherein RRC, PDCP, radio link control (RLC), and MAC layers may be operated by the CRAN/vBBUP and the PHY layer may be operated by individual RAN nodes 222; or a “lower PHY” split wherein RRC, PDCP, RLC, MAC layers and upper portions of the PHY layer may be operated by the CRAN/vBBUP and lower portions of the PHY layer may be operated by individual RAN nodes 222. This virtualized framework may allow freed-up processor cores of RAN nodes 222 to perform or execute other virtualized applications.

In some implementations, an individual RAN node 222 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 220 or by a server pool (e.g., a group of servers configured to share resources) in a similar manner as the CRAN/vBBUP. Additionally, or alternatively, one or more of RAN nodes 222 may be next generation eNBs (i.e., gNBs) that may provide evolved universal terrestrial radio access (E-UTRA) user plane and control plane protocol terminations toward UEs 210, and that may be connected to a 5G core network (5GC) 230 via an NG interface.

Any of the RAN nodes 222 may terminate an air interface protocol and may be the first point of contact for UEs 210. In some implementations, any of the RAN nodes 222 may fulfill various logical functions for the RAN 220 including, but not limited to, radio network controller (RNC) functions such as radio bearer management, uplink and downlink dynamic radio resource management and data packet scheduling, and mobility management. UEs 210 may be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 222 to UEs 210, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 222 may be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 may operate using stand-alone unlicensed operation, licensed assisted access (LAA), eLAA, and/or feLAA mechanisms. In these implementations, UEs 210 and the RAN nodes 222 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The PDSCH may carry user data and higher layer signaling to UEs 210. The physical downlink control channel (PDCCH) may carry information about the transport format and resource allocations related to the PDSCH channel, among other things. The PDCCH may also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) may be performed at any of the RAN nodes 222 based on channel quality information fed back from any of UEs 210. The downlink resource assignment information may be sent on the PDCCH used for (e.g., assigned to) each of UEs 210.

One or more of the techniques, described herein, may enable UE 210 to perform GBBR. For example, UE 210 may provide UE capability information indicating support for MRTD greater than CP to a base station. UE 210 may provide MRTD measurements for multiple TRPs to the base station. UE 210 may receive configuration information for GBBR when MRTD is less than CP or when MRTD is greater than CP for a plurality of TRPs and UE capability information indicates support for MRTD is greater than CP. In some implementations, UE 210 may receive from a base station operating as a TRP configuration information for performing GBBR. UE 210 may determine based on the configuration information a MRTD and communicate to the base station the MRTD in accordance with the performance of GBBR.

The RAN nodes 222 may be configured to communicate with one another via interface 223. In implementations where the system is an LTE system, interface 223 may be an X2 interface. In NR systems, interface 223 may be an Xn interface. The X2 interface may be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 220 may be connected (e.g., communicatively coupled) to CN 230. CN 230 may comprise a plurality of network elements 232, which are configured to offer various data and telecommunications services to customers/subscribers (e.g., users of UEs 210) who are connected to the CN 230 via the RAN 220. In some implementations, CN 230 may include an evolved packet core (EPC), a 5G CN, and/or one or more additional or alternative types of CNs. The components of the CN 230 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 230 may be referred to as a network slice, and a logical instantiation of a portion of the CN 230 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 230, application servers 240, and external networks 250 may be connected to one another via interfaces 234, 236, and 238, which may include IP network interfaces. Application servers 240 may include one or more server devices or network elements (e.g., virtual network functions (VNFs) offering applications that use IP bearer resources with CN 230 (e.g., universal mobile telecommunications system packet services (UMTS PS) domain, LTE PS data services, etc.). Application servers 240 may also, or alternatively, be configured to support one or more communication services (e.g., voice over IP (VOIP sessions, push-to-talk (PTT) sessions, group communication sessions, social networking services, etc.) for UEs 210 via the CN 230. Similarly, external networks 250 may include one or more of a variety of networks, including the Internet, thereby providing the mobile communication network and UEs 210 of the network access to a variety of additional services, information, interconnectivity, and other network features.

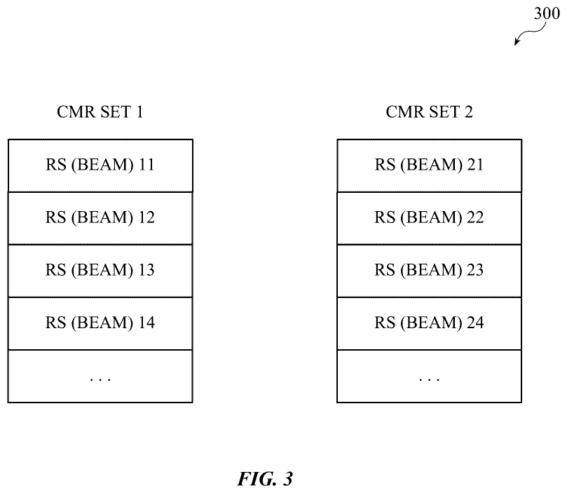

FIG. 3 is a diagram of an example 300 of a representation of two CMR sets, CMR1 310 and CMR2 320, according to an implementation described herein. CMR1 and CMR2 may represent sets of resources allocated by a network (e.g., base station 222) for measuring characteristics of beams received by UE 210. As shown, each CMR set may include resources allocated to reference signals of a base station or TRP. As such, CMR1 may include measurement sets for RS11-RS14, and CMR2 may include resource sets for RS21-RS24.

The network (e.g., base station 222) may configure UE 210 to measure characteristics of each RS transmitted by each TRP. Indeed, each beam may be received by UE 210 from a TRP with a different angle of arrival (AoA) and may exhibits one or more characteristics that may distinguish it from other beams received by UE 210. UE 210 may thus be configured to measure one or more characteristics of the RSs of TRP 120, and one or more characteristics of the RSs of TRP 130. The measurements may be used to determine how well each beam is transmitted by the TRPs toward UE 210, and may be used to determine in which DL transmission directions the network may transmit for reception by UE 210. In particular, the measurements may serve to determine which beams may be simultaneously received by UE 210.

Traditionally, one of the beam characteristics the network may configure the CMR sets to measure is the RSRP or signal strength of each beam. RSRP measurements may enable the network to determine and select beams having sufficient signal strength for reception by UE 210. Implementations of the present disclosure may enable the network to configure additional measurements such as DL Rx timing and RTD to help evaluate signal synchronization between TRPs.

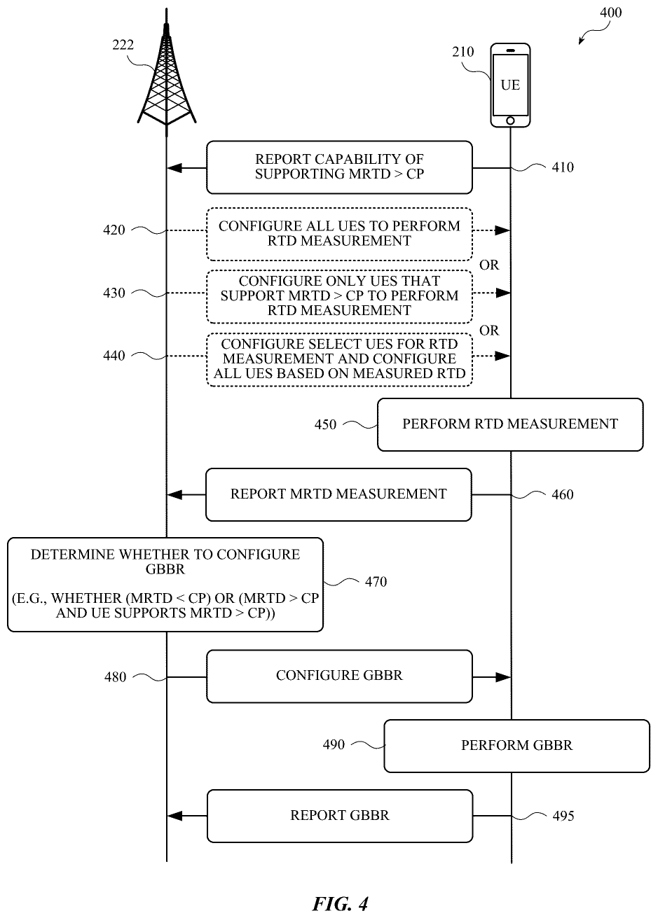

FIG. 4 is a diagram of an example 400 of an GBBR process, according to one or more implementations described herein. Process 400 may be implemented by UE 210 and base station 222. In some implementations, some or all of process 400 may be performed by one or more other systems or devices, including one or more of the devices of FIG. 2. Additionally, process 400 may include one or more fewer, additional, differently ordered and/or arranged operations than those shown in FIG. 4. Some or all of the operations of process 400 may be performed independently, successively, simultaneously, etc., of one or more of the other operations of process 400. Further, one or more of the operations of process 400 may include one or more of the features, conditions, information, characteristics, etc., described elsewhere herein. As such, the techniques described herein are not limited to the number, sequence, arrangement, timing, type, etc., of the operations or processes depicted in FIG. 4.

Process 400 may be implemented when base station 222 is unable to guarantee mTRP network conditions, where MRTD is less than a corresponding CP. Process 400 may involve determining UE capability for measuring and reporting when MRTD is greater than CP and configuring UE 210 to measure MRTD for reporting. UE capability for measuring and reporting when MRTD greater than CP may be determined by receiving UE reports of the presence or absence of such capabilities; the absence of supporting an MRTD greater than CP scenario may also be inferred from a lack of response from UE 210. Base station 222 may configure UE 210 to report RTD measurements to the TRPs. Accordingly, in some implementations, base station 222 may configure UE 210 to measure and report MRTD, and UE 210 may indicate whether UE 210 may support an MRTD greater than CP scenario. Base station 222 may configure UE 210 to measure and report MRTD by configuring “DL Rx Timing” in a TCI state for RSs. MRTD reporting may be configured to all UEs 210, only some UEs 210, or only one UE 210 that supports measuring and reporting when MRTD is greater than CP. Based on the received RTD, base station may configure GBBR for UEs 210 that support MRTD greater than CP scenario, enabling UE scheduling based on traditional GBBR reports in the multi-TRP environment with adverse RTD greater than CP network conditions.

Process 400 may include UE 210 reporting to the network whether UE 210 supports the network condition of MRTD being greater than CP (block 410). Determining whether a UE supports MRTD greater than CP may enable base station 222 to determine whether to configure “DL Rx timing” in a TCI state for UE 210 and therefore configure UE 210 to perform an RTD measurement. Base station 222 may receive UE capability information from multiple UEs 210. For UE 210, the base station 222 may determine that UE 210 is capable of handling MRTD greater than CP conditions when UE 210 reports such capability. The base station 222 may determine that UE 210 has no capability for supporting MRTD greater than CP conditions if the UE reports a lack of such a capability. The base station 222 may also determine that UE 210 has no capability for supporting MRTD greater than CP conditions if UE 210 does not report the capability (in other words, base station 222 may infer a lack of capability of UE 210 from a lack of response from UE 210).

Process 400 may include base station 222 configuring all UEs 210 in the multi-TRP network environment to perform RTD measurements and provide MRTD for TRPs of base station 222 (block 420). In some implementation, to enable UE 210 to measure RTD, base station 222 may configure the QCL property of “DL Rx timing” in a TCI state for RSs for all UEs 210 in the multi-TRP environment. For example, base station 222 may transmit information and/or instructions to UE 210 (e.g., the “DL Rx timing” property) that are configured to cause or enable UE 210 to perform RTD measurements between TRP1 and TRP2 beam pairs (see, e.g., FIG. 1). In such implementations, as this configuration is provided to all UEs 210 in the network environment, UE 210 may be configured to perform the RTD measurement regardless of whether it has reported support for measuring and reporting when an MRTD is greater than CP. The RTD measurement may be configured for UE 210 when UE 210 has actively reported support for measuring and reporting when MRTD is greater than CP or when UE 210 has not reported such support. Configuring “DL Rx timing” for all UEs 210 in the environment thus may enable base station 222 to skip the steps of determining which UEs 210 support for measuring and reporting when the MRTD is greater than CP. However, configuring a measurement may incur a measurement overhead at UE 210. For example, UE 210 may have to pause data reception to perform the RTD measurement. As a result, the measurement overhead incurred by requesting every UE 210 to perform an RTD measurement regardless of support for MRTD greater than CP network conditions may yield an inefficient network operation in some examples. These inefficiencies may be mitigated or avoided by limiting the configuration of “DL Rx timing” in a TCI state for RSs and the RTD measurement request to a subset of UEs 210 in the multi TRP environment, as will be described in the alternative steps that follow.

As shown, process 400 may include base station 222 configuring only UEs 210 that support the network condition of MRTD greater than CP to perform RTD measurements and provide an MRTD to base station 222 (block 430). In some implementation, to enable UEs 210 to measure RTD, base station 222 may configure a QCL property of “DL Rx timing” in a TCI state for RSs only for a pool of UEs 210 that have reported support for MRTD greater than CP (at block 410). Base station 222 may forego configuring for the RTD measurement and reporting the UEs 210 that reported a lack of MRTD greater CP capability or that have not reported at all. Limiting the RTD measurement to a subset of UEs 210. may prevent over encumbrance of UEs that do not support MRTD greater than CP network conditions with measurements that are useless to the network. Configuring a measurement may incur a measurement overhead at UE 210, for example, causing UE 210 to pause reception to perform an RTD measurement. Limiting the request to measure the RTD to the pool or subset of UEs 210 that support network conditions where such measurements can be useful (e.g., when MRTD is greater than CP) may promote network efficiency.

As shown, in some implementations, process 400 may include the base station 222 configuring select UEs 210 at different locations of the multi-TRP environment to perform RTD measurements and provide MRTD to base station 222 (block 440). In some implementation, to enable the UEs 210 to measure RTD, base station 222 may configure the QCL property of “DL Rx timing” in a TCI state for the select UEs 210 in the network environment. Base station 222 may utilize the multiple reports of MRTD at different locations to determine whether network conditions warrant configuring all UEs 210 for MRTD measurement and reporting based on whether and where MRTD greater than CP is observed. For example, base station 222 may determine based on the MRTD reports from multiple UEs 210 at different locations that a network condition of MRTD greater than CP is widespread enough to warrant configuring all UEs 210 in the network environment for MRTD reporting. Alternatively, base station 222 may determine based on the limited reports that MRTD is less than CP across the network such that no MRTD reporting from additional UEs 210 is warranted.

Process 400 may include the UE 210 performing the RTD measurement (block 450) as configured by the base station 222. UE 210 may perform RTD measurements based on information and/or instructions received from base station 222 that are configured to cause or enable UE 210 to perform RTD measurements between beams beam pairs, as previously described. In some implementations, RTD measurements at UE 210 may be enabled by base station 222′s configuration of the QCL property of “DL Rx timing” in a TCI state. For example, performing the RTD measurement may include determining the DL timing for each RS (i.e., RS11-RS14) of TRP 120 and each RS (i.e., R21-R24) of TRP 130 as listed in the representations of CMR sets CMR1 and CMR2 in FIG. 3.

Process 400 may include reporting RTD measurements to base station 222 (block 460). UE 210 may thus transmit information and/or instructions to base station 222 that include the measured RTD.

Process 400 may include determining whether to configure UE 210 for GBBR (block 470). Base station 222 may perform this determination based on the network condition report (whether RTD is greater than CP) provided by UE 210 at block 460 and UE capability report (whether UE 210 supports MRTD greater than CP) provided by UE 210 at block 410. If the RTD as measured and provided by UE 210 is less than CP, this indicates that network conditions may be favorable to coordinated service between UE 210 and TRPs (such as TRP 120 and TRP 130 as shown in FIG. 1) in the multi-TRP environment. In that scenario, UE 210 support for MRTD greater than CP network conditions may be ignored. In this case, base station 222 may configure UE 210 for GBBR (block 480). Configuring UE 210 for GBBR can include setting a parameter that enables the UE 210 to perform GBBR and transmit a GBBR report to base station 222. If RTD as measured and provided by UE 210 is greater than CP, network conditions may be less favorable for coordinated transmission from multiple TRPs and GBBR can be performed only if UE 210 has reported support for MRTD greater than CP (see block 410). In this case, base station 222 may also configure UE 210 for GBBR for the two TRPs (block 480). Accordingly, in this implementation, base station 222 may configure GBBR for the two TRPs to enable UE 210 to report on beam pairs based on RSRP when either MRTD as reported by the UE 210 at block 410 is less than CP, or when MRTD is greater than CP and UE 210 has reported support for MRTD greater than CP. When MRTD is greater than CP but UE 210 either has reported that it does not support this network condition, or that the UE 210 has failed to report on its capability to support the MRTD greater than CP condition, GBBR may not be configured and a simultaneous physical data shared channel (PDSCH) may not be scheduled.

Process 400 may include UE 210 performing GBBR (block 490) and reporting to base station 222 RS beam pairs based on measured RSRP (block 495). In this implementation, as previously described, GBBR may be performed when either MRTD as reported by UE 210 at block 410 is less than CP, or when MRTD is greater than CP and UE 210 has reported support for MRTD greater than CP. The GBBR may enable base station 222 to select beam pairs for optimal DL reception at UE 210.

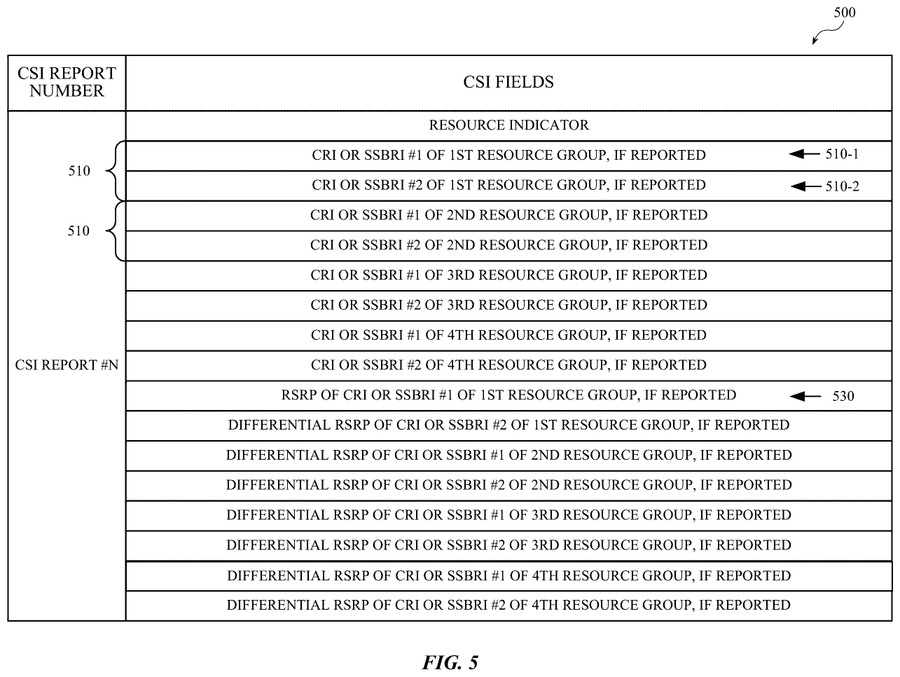

FIG. 5 is a diagram of an example of a data structure of an example GBBR report according to one or more implementations described herein. GBBR report 500 may provide information about DL beams received at UE 210 from TRPs in a multi-TRP environment to enable base station 222 to select beam pairs for optimal DL Rx at the UE 210. In particular, the GBBR report 500 to base station 222 may report RS beam pairs 510 based on measured reference signal received power (RSRP) or signal strength. The GBBR report 500 may provide the report as a channel state information (CSI) report that includes resource groups, each resource group often comprising a pair of beams (e.g., 510-1, 510-2) that UE 210 is able to receive simultaneously. Each beam may be identified by either a CSI Resource Indicator (CRI) or a SS/PBCH Block Resource Indicator (SSBRI). The first beam (e.g., 510-1) of each pair 510 or resource group may be received from TRP 120 and the second beam (510-2) of the resource group 510 may be received from TRP 130. The GBBR report 500 may further identify the beam 530 having the largest measured RSRP (the beam having the strongest signal). The RSRPs of other beams of the report may be provided as differential RSRPs (against the strongest signal 530), which may facilitate the assessment of signal strength between different beams of the report.

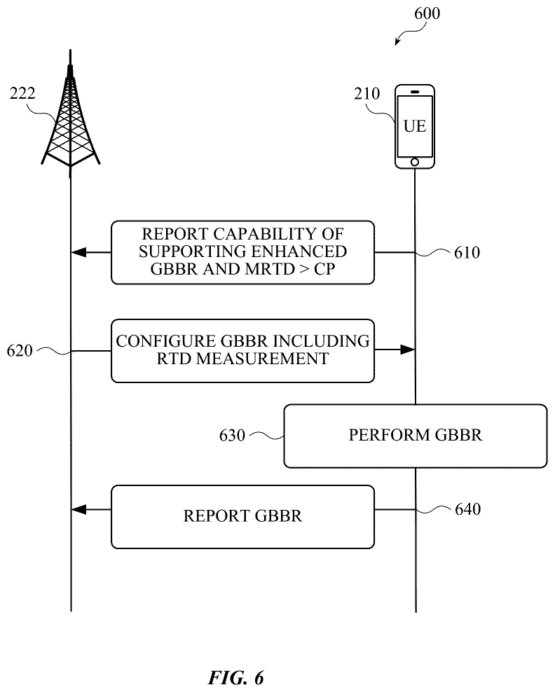

FIG. 6 is a diagram of an example of an example of enhanced GBBR with MRTD reporting for mTRPs according to one or more implementations described herein. Process 600 may be implemented by UE 210 and base station 222. In some implementations, some or all of process 400 may be performed by one or more other systems or devices, including one or more of the devices of FIG. 2. Additionally, process 600 may include one or more fewer, additional, differently ordered and/or arranged operations than those shown in FIG. 6. Some or all of the operations of process 600 may be performed independently, successively, simultaneously, etc., of one or more of the other operations of process 600. Further, one or more of the operations of process 600 may include one or more of the features, conditions, information, characteristics, etc., described elsewhere herein. As such, the techniques described herein are not limited to the number, sequence, arrangement, timing, type, etc., of the operations or processes depicted in FIG. 6.

Process 600 may include UE 210 reporting to base station 222 whether the UE 210 supports enhanced GBBR and supports MRTD greater than CP (block 610). Determining whether UE 210 supports enhanced GBBR (i.e., measuring and reporting RTD) and MRTD greater than CP, enables base station 222 to determine whether to configure “DL Rx timing” in a TCI state for the UE 210 and therefore configure the UE 210 to perform an RTD measurement. Base station 222 may receive UE capability report from multiple UEs. For a UE 210, base station 222 determines that the UE 210 is capable of handling MRTD greater than CP if the UE 210 reports such capability. Base station 222 may determine that a UE 210 has no capability for MRTD greater than CP if the UE 210 reports a lack of such capability. Base station 222 may also determine that the UE 210 has no capability for MRTD greater than CP conditions if the UE 210 does not report on the capability (in other words, base station 222 can infer the lack of capability from the lack of response from a UE).

Process 600 may further include base station 222 configuring an RTD measurement to the UE as part of enhanced GBBR (block 620). Unlike process 400, process 600 may dispense with configuring an RTD measurement at UE 210 before base station 222 configures GBBR to the UE 210. Instead, base station 222 configures the RTD measurement to UE 210 as part of GBBR. Accordingly, base station 222 may configure GBBR for the two TRPs (TRP 120 and TRP 130). Configuring a GBBR for the two TRPs may include setting a parameter that enables UE 210 to perform GBBR and transmit a GBBR report to base station 222. The configuration may further include one or more parameters that are instructions to cause UE 210 to perform and report RTD measurements in addition to the RSRP measurements for beams grouped in beam pairs as described in reference to FIG. 5. The RTD measurements provided to base station 222 as part of GBBR for each beam pair may enable base station 222 to selected beam pairs for optimal coordinated transmissions by the two TRPs based on timing or synchronization factors (RTD) in addition to signal strength (RSRP). UE 210 performs GBBR (block 630) and reports to the TRP (block 640).

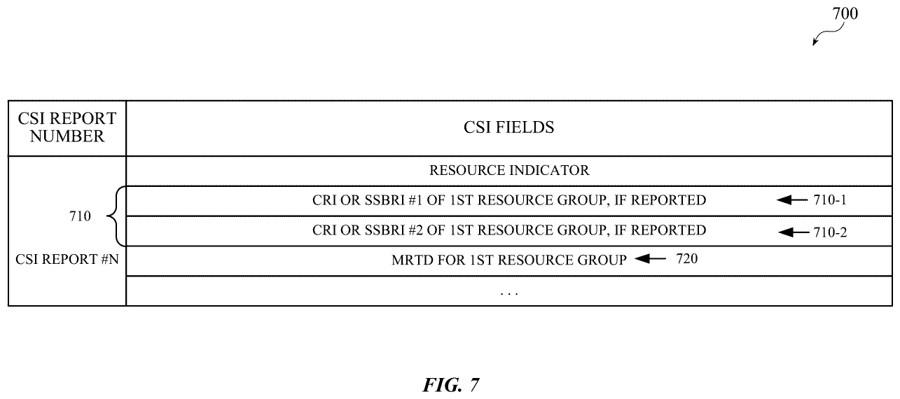

FIG. 7 is a diagram of an example of a representation of a data structure of an example enhanced GBBR report according to one or more implementations described herein. As previously described in reference to FIG. 5, the enhanced GBBR report 700 to base station 222 may report RS beam pairs based on measured RSRP or signal strength. The GBBR report 700 may exhibit the same report structure as report 500, and thus may provide the report as a channel state information (CSI) report that includes resource groups, each resource group comprising a pair of beams that UE 210 is able to receive simultaneously. Each beam may be identified by either CSI Resource Indicator (CRI) or its SS/PBCH Block Resource Indicator (SSBRI). As with report 500, the first beam 710-1 of each pair or resource group 710 may be received from TRP 120 (e.g., RS11-14 as listed in FIG. 3) and the second beam 710-2 of the resource group may be received from TRP 130 (e.g., RS21-24). However, base station 222 may also have configured MRTD measurements as part of enhanced GBBR 700, as previously described. The configuration thus may include one or more parameters that are instructions to cause the UE 210 to perform and report RTD measurements in addition to the RSRP measurements for beams grouped in beam pairs as described in reference to FIG. 5. Thus in FIG. 7, enhanced GBBR 700 may also provide MRTD 720 for each resource group or beam pair 710. As illustrated, the MRTD measurement 720 is shown for the first resource group or beam pair. MRTD measurement 720 thus is provided for every beam pair 710 in the enhanced report 700. The RTD measurements provided to base station 222 as part of the enhanced GBBR 700 for each beam pair 710 may enable base station 222 to selected beam pairs for optimal coordinated transmissions by two TRPs (e.g., TRP 120 and TRP 130) based on timing or synchronization parameters (RTD) in addition to signal strength (RSRP).

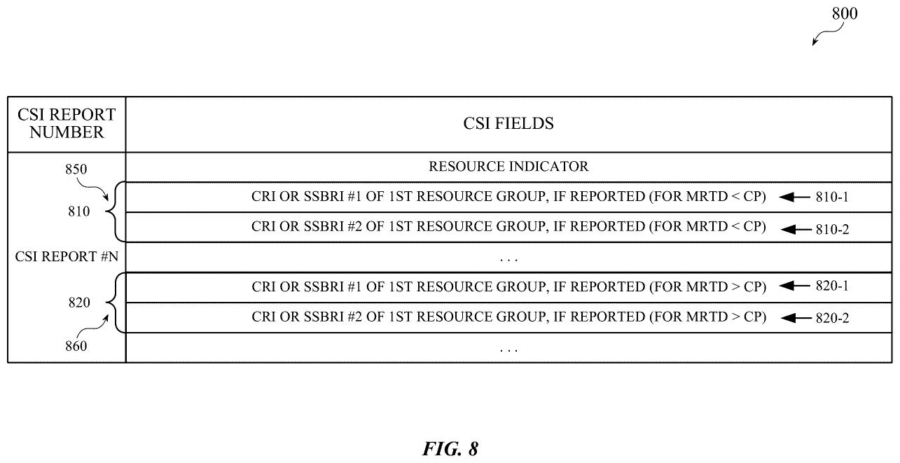

FIG. 8 is a diagram of an example of a representation of a data structure of an example enhanced GBBR report according to another example of the disclosure. In this implementation, base station 222 may configure the UE 210 to provide enhanced GBBR 800 as a two-part data structure. In some implementations, each part may duplicate GBBR report 500's reporting structure as described in reference to FIG. 5. Accordingly, enhanced GBBR report 800 to base station 222 may report RS beam pairs based on measured reference signal received power (RSRP) or signal strength. The enhanced GBBR report 800 may exhibit a similar report structure as report 500, and may thus provide the report 800 as a channel state information (CSI) report that may include resource groups, each resource group comprising a pair of beams that the UE is able to receive simultaneously. Each beam may be identified by either CSI Resource Indicator (CRI) or its SS/PBCH Block Resource Indicator (SSBRI). As with report 500, the first beam 810-1 of each pair or resource group 810 may be received from TRP 120 (e.g., RS 11-14 as listed in FIG. 3) and the second beam 810-2 of the resource group 810 may be received from TRP 130. As with report 700, base station 222 may also have configure MRTD measurements as part of enhanced GBBR report 800. The configuration may thus include one or more parameters that are instructions to cause the UE 210 to perform and report RTD measurements in addition to the RSRP measurements for beams grouped in beam pairs as described in reference to FIG. 5. However, base station 222 may also configure GBBR 800 to group the reports by whether MRTD is greater than CP and/or whether MRTD is less than CP for any resource group or beam pair 810. Accordingly, in a first GBBR part 850, the GBBR 800 may report RS beam pairs 810 (formed by beam 810-1 and 810-2) that support MRTD less than CP. GBBR part 850 may comprise the whole of the GBBR 800 in cases where base station 222 has configured a report only for beam pairs that satisfy MRTD less than CP condition. Additionally, or alternatively, GBBR 800 may include a second GBBR part 860 configured to report beam pairs 820 that support MRTD greater than CP. The GBBR part 860 may comprise the whole of GBBR 800 in cases where base station 222 has configured a report only for beam pairs that satisfy MRTD greater than CP. The grouping of resource groups or beam pairs by MRTD less or more than CP is provided to base station 222 as part of enhanced GBBR 800 to enable base station 222 to selected beam pairs for optimal coordinated transmissions by two TRPs (e.g., TRP 120 and TRP 130) based on synchronization parameters (MRTD) in addition to signal strength (RSRP).

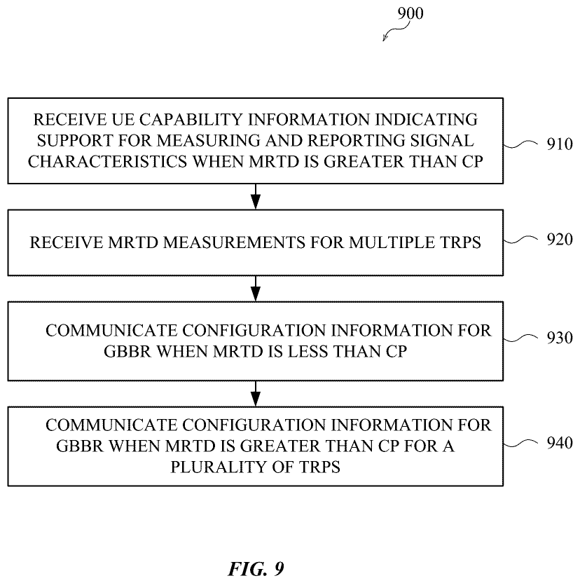

FIG. 9 is a diagram of an example of a process 900 for enhanced GBBR with MRTD reporting for mTRPs according to one or more implementations described herein. In some scenarios, process 900 may include receiving (910), from a UE of a plurality of UEs, UE capability information indicating support for when a MRTD is greater than a corresponding CP. In some scenarios, the process may comprise receiving (920), from the UE, MRTD measurements for multiple transmission and reception points (TRPs). In some scenarios, the process may include communicating (930), to the UE, configuration information for GBBR when MRTD is less than the corresponding CP. In some scenarios, the process may also include communicating (940), to the UE, configuration information for GBBR when MRTD is greater than the corresponding CP for a plurality of TRPs.

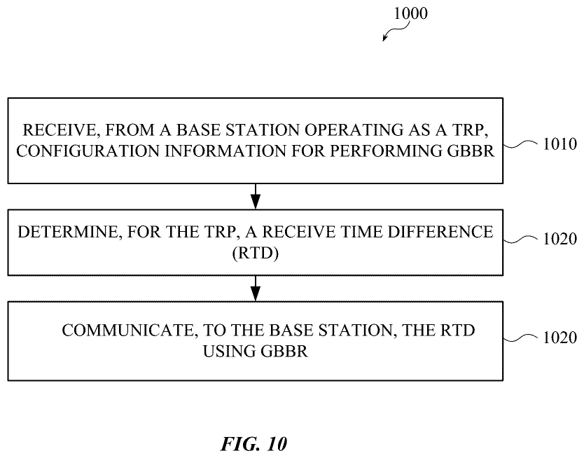

FIG. 10 is a diagram of an example of a process 1000 for enhanced GBBR with MRTD reporting for mTRPs according to one or more implementations described herein. In some scenarios, a UE may comprise a memory and one or more processors configured to, when executing instructions stored in the memory, cause the UE to receive (1010), from a base station operating as a transmission and reception point (TRP), configuration information for performing group-based beam reporting (GBBR). In some scenarios, the one or more processors may be configured to, when executing instructions stored in the memory, cause the UE to determine (1020), for the TRP, a receiving timing difference (RTD). In some scenarios, the one or more processors may be configured to, when executing instructions stored in the memory, cause the UE to communicate (1030), to the base station, the RTD using GBBR.

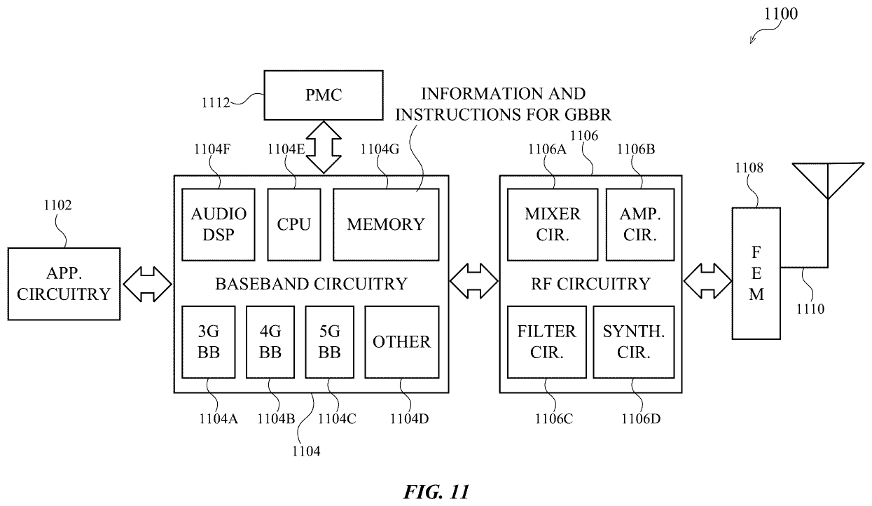

FIG. 11 is a diagram of an example of components of a device according to one or more implementations described herein. In some implementations, the device 1100 can include application circuitry 1102, baseband circuitry 1104, RF circuitry 1106, front-end module (FEM) circuitry 1108, one or more antennas 1110, and power management circuitry (PMC) 1112 coupled together at least as shown. The components of the illustrated device 1100 can be included in a UE or a RAN node. In some implementations, the device 1100 can include fewer elements (e.g., a RAN node may not utilize application circuitry 1102, and instead include a processor/controller to process IP data received from a CN or an Evolved Packet Core (EPC)). In some implementations, the device 1100 can include additional elements such as, for example, memory/storage, display, camera, sensor (including one or more temperature sensors, such as a single temperature sensor, a plurality of temperature sensors at different locations in device 1100, etc.), or input/output (I/O) interface. In other implementations, the components described below can be included in more than one device (e.g., said circuitries can be separately included in more than one device for Cloud-RAN (C-RAN) implementations).

The application circuitry 1102 can include one or more application processors. For example, the application circuitry 1102 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1100. In some implementations, processors of application circuitry 1102 can process IP data packets received from an EPC.

The baseband circuitry 1104 can include circuitry such as, but not limited to, one or more single-core or multi-core processors. The baseband circuitry 1104 can include one or more baseband processors or control logic to process baseband signals received from a receive signal path of the RF circuitry 1106 and to generate baseband signals for a transmit signal path of the RF circuitry 1106. Baseband circuity 1104 can interface with the application circuitry 1102 for generation and processing of the baseband signals and for controlling operations of the RF circuitry 1106. For example, in some implementations, the baseband circuitry 1104 can include a 3G baseband processor 1104A, a 4G baseband processor 1104B, a 5G baseband processor 1104C, or other baseband processor(s) 1104D for other existing generations, generations in development or to be developed in the future (e.g., 5G, 6G, etc.). The baseband circuitry 1104 (e.g., one or more of baseband processors 1104A-D) can handle various radio control functions that enable communication with one or more radio networks via the RF circuitry 1106. In other implementations, some or all of the functionality of baseband processors 1104A-D can be included in modules stored in the memory 1104G and executed via a Central Processing Unit (CPU) 1104E. The radio control functions can include, but are not limited to, signal modulation/demodulation, encoding/decoding, radio frequency shifting, etc. In some implementations, modulation/demodulation circuitry of the baseband circuitry 1104 can include Fast-Fourier Transform (FFT), precoding, or constellation mapping/de-mapping functionality. In some implementations, encoding/decoding circuitry of the baseband circuitry 1104 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 1104G may receive and/or store information and instructions for enabling UE 210, and/or one or more components thereof, to perform GBBR. For example, the information and instructions may cause and/or enable UE 210 to provide UE capability information indicating support for MRTD greater than CP to a base station. The information and instructions may cause and/or enable UE 210 to provide RTD measurements for multiple TRPs to the base station. The information and instructions may cause and/or enable UE 210 to receive configuration information for GBBR when MRTD is less than CP or when MRTD is greater than CP for a plurality of TRPs. In some implementations, the information and instructions may cause and/or enable UE 210 to receive from a base station operating as a TRP configuration information for GBBR. The information and instructions may cause and/or enable UE 210 to determine for the TRP a RTD and communicate to the base station the RTD using GBBR.

In some implementations, the baseband circuitry 1104 can include one or more audio digital signal processor(s) (DSP) 1104F. The audio DSPs 1104F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1104 and the application circuitry 1102 can be implemented together such as, for example, on a system on a chip (SOC).

In some implementations, the baseband circuitry 1104 can provide for communication compatible with one or more radio technologies. For example, in some implementations, the baseband circuitry 1104 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1104 is configured to support radio communications of more than one wireless protocol can be referred to as multi-mode baseband circuitry.

RF circuitry 1106 can enable communication with wireless networks using modulated electromagnetic radiation through a non-solid medium. In various implementations, the RF circuitry 1106 can include switches, filters, amplifiers, etc. to facilitate the communication with the wireless network. RF circuitry 1106 can include a receive signal path which can include circuitry to down-convert RF signals received from the FEM circuitry 1108 and provide baseband signals to the baseband circuitry 1104. RF circuitry 1106 can also include a transmit signal path which can include circuitry to up-convert baseband signals provided by the baseband circuitry 1104 and provide RF output signals to the FEM circuitry 1108 for transmission.

In some implementations, the receive signal path of the RF circuitry 1106 can include mixer circuitry 1106A, amplifier circuitry 1106B and filter circuitry 1106C. In some implementations, the transmit signal path of the RF circuitry 1106 can include filter circuitry 1106C and mixer circuitry 1106A. RF circuitry 1106 can also include synthesizer circuitry 1106D for synthesizing a frequency for use by the mixer circuitry 1106A of the receive signal path and the transmit signal path. In some implementations, the mixer circuitry 1106A of the receive signal path can be configured to down-convert RF signals received from the FEM circuitry 1108 based on the synthesized frequency provided by synthesizer circuitry 1106D. The amplifier circuitry 1106B can be configured to amplify the down-converted signals and the filter circuitry 1106C can be a low-pass filter (LPF) or band-pass filter (BPF) configured to remove unwanted signals from the down-converted signals to generate output baseband signals. Output baseband signals can be provided to the baseband circuitry 1104 for further processing. In some implementations, the output baseband signals can be zero-frequency baseband signals, although this is not a requirement. In some implementations, mixer circuitry 1106A of the receive signal path can comprise passive mixers, although the scope of the implementations is not limited in this respect.

In some implementations, the mixer circuitry 1106A of the transmit signal path can be configured to up-convert input baseband signals based on the synthesized frequency provided by the synthesizer circuitry 1106D to generate RF output signals for the FEM circuitry 1108. The baseband signals can be provided by the baseband circuitry 1104 and can be filtered by filter circuitry 1106C.

In some implementations, the mixer circuitry 1106A of the receive signal path and the mixer circuitry 1106A of the transmit signal path can include two or more mixers and can be arranged for quadrature down conversion and up conversion, respectively. In some implementations, the mixer circuitry 1106A of the receive signal path and the mixer circuitry 1106A of the transmit signal path can include two or more mixers and can be arranged for image rejection (e.g., Hartley image rejection). In some implementations, the mixer circuitry 1106A of the receive signal path and the mixer circuitry 1106A can be arranged for direct down conversion and direct up conversion, respectively. In some implementations, the mixer circuitry 1106A of the receive signal path and the mixer circuitry 1106A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 1106 can include analog-to-digital converter (ADC) and digital-to-analog converter (DAC) circuitry and the baseband circuitry 1104 can include a digital baseband interface to communicate with the RF circuitry 1106.

In some dual-mode implementations, a separate radio IC circuitry can be provided for processing signals for each spectrum, although the scope of the implementations is not limited in this respect.

In some implementations, the synthesizer circuitry 1106D can be a fractional-N synthesizer or a fractional N/N+1 synthesizer, although the scope of the implementations is not limited in this respect as other types of frequency synthesizers can be suitable. For example, synthesizer circuitry 1106D can be a delta-sigma synthesizer, a frequency multiplier, or a synthesizer comprising a phase-locked loop with a frequency divider.

The synthesizer circuitry 1106D can be configured to synthesize an output frequency for use by the mixer circuitry 1106A of the RF circuitry 1106 based on a frequency input and a divider control input. In some implementations, the synthesizer circuitry 1106D can be a fractional N/N+1 synthesizer.

In some implementations, frequency input can be provided by a voltage-controlled oscillator (VCO), although that is not a requirement. Divider control input can be provided by either the baseband circuitry 1104 or the applications circuitry 1102 depending on the desired output frequency. In some implementations, a divider control input (e.g., N) can be determined from a look-up table based on a channel indicated by the applications circuitry 1102.

Synthesizer circuitry 1106D of the RF circuitry 1106 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1106D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1106 can include an IQ/polar converter.

FEM circuitry 1108 can include a receive signal path which can include circuitry configured to operate on RF signals received from one or more antennas 1110, amplify the received signals and provide the amplified versions of the received signals to the RF circuitry 1106 for further processing. FEM circuitry 1108 can also include a transmit signal path which can include circuitry configured to amplify signals for transmission provided by the RF circuitry 1106 for transmission by one or more of the one or more antennas 1110. In various implementations, the amplification through the transmit or receive signal paths can be done solely in the RF circuitry 1106, solely in the FEM circuitry 1108, or in both the RF circuitry 1106 and the FEM circuitry 1108.

In some implementations, the FEM circuitry 1108 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1106). The transmit signal path of the FEM circuitry 1108 can include a power amplifier (PA) to amplify input RF signals (e.g., provided by RF circuitry 1106), and one or more filters to generate RF signals for subsequent transmission (e.g., by one or more of the one or more antennas 1110).

In some implementations, the PMC 1112 can manage power provided to the baseband circuitry 1104. In particular, the PMC 1112 can control power-source selection, voltage scaling, battery charging, or DC-to-DC conversion. The PMC 1112 can often be included when the device 1100 is capable of being powered by a battery, for example, when the device is included in a UE. The PMC 1112 can increase the power conversion efficiency while providing desirable implementation size and heat dissipation characteristics.

While FIG. 11 shows the PMC 1112 coupled only with the baseband circuitry 1104. However, in other implementations, the PMC 1112 may be additionally or alternatively coupled with, and perform similar power management operations for, other components such as, but not limited to, application circuitry 1102, RF circuitry 1106, or FEM circuitry 1108.

In some implementations, the PMC 1112 can control, or otherwise be part of, various power saving mechanisms of the device 1100. For example, if the device 1100 is in an RRC_Connected state, where it is still connected to the RAN node as it expects to receive traffic shortly, then it can enter a state known as Discontinuous Reception Mode (DRX) after a period of inactivity. During this state, the device 1100 can power down for brief intervals of time and thus save power.

If there is no data traffic activity for an extended period of time, then the device 1100 can transition off to an RRC_Idle state, where it disconnects from the network and does not perform operations such as channel quality feedback, handover, etc. The device 1100 goes into a very low power state and it performs paging where again it periodically wakes up to listen to the network and then powers down again. The device 1100 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1102 and processors of the baseband circuitry 1104 can be used to execute elements of one or more instances of a protocol stack. For example, processors of the baseband circuitry 1104, alone or in combination, can be used execute Layer 3, Layer 2, or Layer 1 functionality, while processors of the baseband circuitry 1104 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

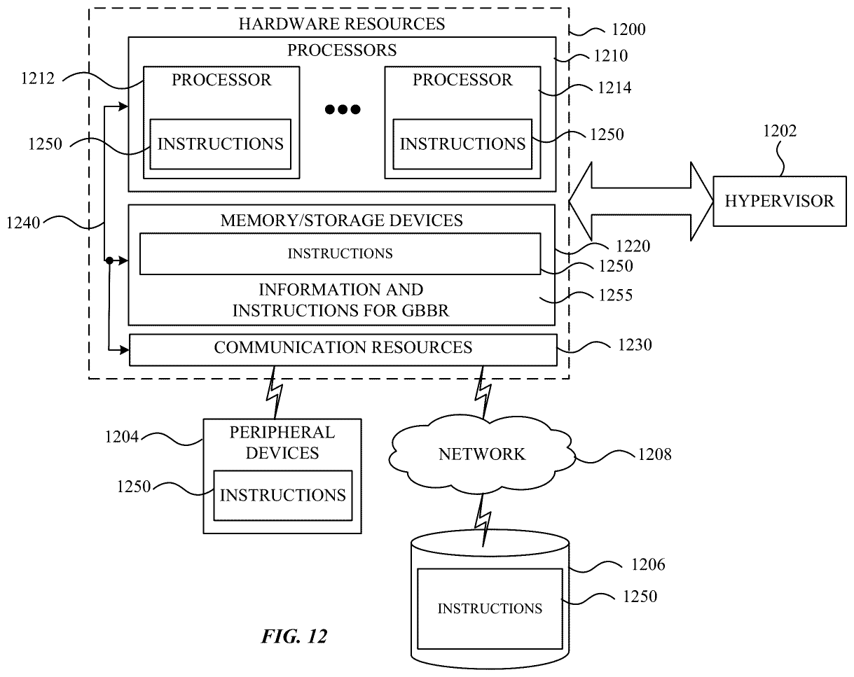

FIG. 12 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 12 shows a diagrammatic representation of hardware resources 1200 including one or more processors (or processor cores) 1210, one or more memory/storage devices 1220, and one or more communication resources 1230, each of which may be communicatively coupled via a bus 1240. For implementations where node virtualization (e.g., NFV) is utilized, a hypervisor 1202 may be executed to provide an execution environment for one or more network slices/sub-slices to utilize the hardware resources 1200.

The processors 1210 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1212 and a processor 1214.

The memory/storage devices 1220 may include main memory, disk storage, or any suitable combination thereof. The memory/storage devices 1220 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1220 receive and/or store information and instructions 1255 for enabling UE 210, and/or one or more components thereof, to perform GBBR. For example, the information and instructions may cause and/or enable UE 210 to provide UE capability information indicating support for MRTD greater than CP to a base station. The information and instructions may cause and/or enable UE 210 to provide RTD measurements for multiple TRPs to the base station. The information and instructions may cause and/or enable UE 210 to receive configuration information for GBBR when MRTD is less than CP or when MRTD is greater than CP for a plurality of TRPs. In some implementations, the information and instructions may cause and/or enable UE 210 to receive from a base station operating as a TRP configuration information for GBBR. The information and instructions may cause and/or enable UE 210 to determine for the TRP a RTD and communicate to the base station the RTD using GBBR.

The communication resources 1230 may include interconnection or network interface components or other suitable devices to communicate with one or more peripheral devices 1204 or one or more databases 1206 via a network 1208. For example, the communication resources 1230 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1250 may comprise software, a program, an application, an applet, an app, or other executable code for causing at least any of the processors 1210 to perform any one or more of the methodologies discussed herein. The instructions 1250 may reside, completely or partially, within at least one of the processors 1210 (e.g., within the processor's cache memory), the memory/storage devices 1220, or any suitable combination thereof. Furthermore, any portion of the instructions 1250 may be transferred to the hardware resources 1200 from any combination of the peripheral devices 1204 or the databases 1206. Accordingly, the memory of processors 1210, the memory/storage devices 1220, the peripheral devices 1204, and the databases 1206 are examples of computer-readable and machine-readable media.

Examples and/or implementations herein may include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a method may comprise receiving, from a user equipment (UE) of a plurality of UEs, UE capability information indicating support for when a maximum received timing difference (MRTD) is greater than a corresponding cycle prefix (CP); receiving, from the UE, MRTD measurements for multiple transmission and reception points (TRPs); communicating, to the UE, configuration information for group-based beam reporting (GBBR) when MRTD is less than the corresponding CP or when MRTD is greater than the corresponding CP for a plurality of TRPs and the UE capability information indicates support for when MRTD is greater than the corresponding CP.

In example 2, which may also include one or more of the examples described herein, the method further comprises communicating to all UEs of the plurality of UEs, configuration information for performing the MRTD measurements.

In example 3, which may also include one or more of the examples described herein, the method further comprises communicating to UEs of the plurality of UEs from which the UE capability information was received indicating support for when MRTD is greater than the corresponding CP, configuration information for performing the MRTD measurements.

In example 4, which may also include one or more of the examples described herein, the method further comprises: communicating to one or more UEs of the plurality of UEs located at different locations, configuration information for performing the MRTD measurements; receiving, from the one or more UEs, the MRTD measurements for TRPs; and communicating, to all UEs of the plurality of UEs, configuration information for performing the MRTD measurements.

In example 5, which may also include one or more of the examples described herein, communicating configuration information for performing the MRTD measurements comprises configuring DL Rx timing in a transmission configuration indicator (TCI) state for reference signals (RS) to enable UEs to perform the MRTD measurements.

In example 6, which may also include one or more of the examples described herein, the GBBR comprises one or more pairs of identifiers for reference signals (RS), each RS of a pair received from a different TRP and identified by the UE for simultaneous reception.

In example 7, which may also include one or more of the examples described herein, the method further comprises receiving the GBBR report and scheduling the UE based on the GBBR report.

In example 8, which may also include one or more of the examples described herein, a method comprises communicating, to a user equipment (UE), configuration information for performing group-based beam reporting (GBBR), the configuration information including configuration information for performing a received timing difference (RTD) measurement; receiving GBBR information comprising a timing measurement; and communicating, to the UE, scheduling information based on the GBBR information.

In example 9, which may also include one or more of the examples described herein, the timing measurement comprises a determination of a maximum RTD (MRTD).

In example 10, which may also include one or more of the examples described herein, the GBBR information comprises one or more pairs of reference signal (RS) identifiers, each RS of a pair received from a different transmission and reception point (TRP) and identified by the UE for simultaneous reception. In example 11, which may also include one or more of the examples described herein, the GBBR information further comprises a MRTD measurement associated with each pair of RS. In example 12, which may also include one or more of the examples described herein, performing the RTD measurement comprises determining whether a MRTD is greater or less than a corresponding cycle prefix (CP) and wherein the GBBR information comprises a first GBBR information part comprising RS pairs that satisfy MRTD greater than the corresponding CP and a second GBBR information part comprising RS pairs that satisfy MRTD less than the corresponding CP.

In example 13, which may also include one or more of the examples described herein, a user device (UE), may comprise: a memory; and one or more processors configured to, when executing instructions stored in the memory, cause the UE to: receive, from a base station operating as a transmission and reception point (TRP), configuration information for performing group-based beam reporting (GBBR); determine, based on the configuration information a maximum receive timing difference (MRTD) based on a plurality of reference signals (RS), each RS of the plurality of RS being received from a different TRP; and communicate, to the base station, the MRTD in accordance with performance of the GBBR.

In example 14, which may also include one or more of the examples described herein, the GBBR comprises one or more pairs of RS, each RS identifier of the one or more pairs of RS identifiers corresponding to a RS of the plurality of RS, each of the one or more pairs of RS identifiers being identified by the UE for simultaneous reception. In example 15, which may also include one or more of the examples described herein, the GBBR further comprises a MRTD measurement associated with each of the one or more pairs of RS identifiers. In example 16, which may also include one or more of the examples described herein, the MRTD measurement comprises a determination of whether MRTD is greater or less than a corresponding cycle prefix (CP). In example 17, which may also include one or more of the examples described herein, the GBBR comprises a first GBBR part comprising RS pairs that satisfy MRTD greater than the corresponding CP. In example 18, which may also include one or more of the examples described herein, the GBBR comprises a second GBBR part comprising RS pairs that satisfy MRTD less than the corresponding CP.

In example 19, which may also include one or more of the examples described herein, the configuration information includes an instruction to perform a MRTD measurement.

In example 20, which may also include one or more of the examples described herein, a baseband processor may comprise: one or more processors configured to: receive, from a base station operating as a transmission and reception point (TRP), configuration information for performing group-based beam reporting (GBBR); determine, based on the configuration information a maximum receive timing difference (MRTD) based on a plurality of reference signals (RS), each RS of the plurality of RS being received from a different TRP; and communicate, to the base station, the MRTD in accordance with performance of the GBBR.

In example 21, which may also include one or more of the examples described herein, the GBBR comprises one or more pairs of RS, each RS identifier of the one or more pairs of RS identifiers corresponding to a RS of the plurality of RS, each of the one or more pairs of RS identifiers being identified by the baseband processor for simultaneous reception. In example 22, which may also include one or more of the examples described herein, the GBBR further comprises a MRTD measurement associated with each of the one or more pairs of RS identifiers. In example 23, which may also include one or more of the examples described herein, the MRTD measurement comprises a determination of whether MRTD is greater or less than a corresponding cycle prefix (CP). In example 24, which may also include one or more of the examples described herein, the GBBR comprises a first GBBR part comprising RS pairs that satisfy MRTD greater than the corresponding CP. In example 25, which may also include one or more of the examples described herein, the GBBR comprises a second GBBR part comprising RS pairs that satisfy MRTD less than the corresponding CP.

In example 26, which may also include one or more of the examples described herein, the configuration information includes an instruction to perform a MRTD measurement.

In example 27, which may also include one or more of the examples described herein, a method at a user equipment (UE) may comprise receiving, from a base station operating as a transmission and reception point (TRP), configuration information for performing group-based beam reporting (GBBR); determining, based on the configuration information a maximum receive timing difference (MRTD) based on a plurality of reference signals (RS), each RS of the plurality of RS being received from a different TRP; and communicating, to the base station, the MRTD in accordance with performance of the GBBR.

In example 28, which may also include one or more of the examples described herein, the GBBR comprises one or more pairs of RS, each RS identifier of the one or more pairs of RS identifiers corresponding to a RS of the plurality of RS, each of the one or more pairs of RS identifiers being identified by the UE for simultaneous reception. In example 29, which may also include one or more of the examples described herein, the GBBR further comprises a MRTD measurement associated with each of the one or more pairs of RS identifiers. In example 30, which may also include one or more of the examples described herein, the MRTD measurement comprises a determination of whether MRTD is greater or less than a corresponding cycle prefix (CP). In example 31, which may also include one or more of the examples described herein, the GBBR comprises a first GBBR part comprising RS pairs that satisfy MRTD greater than the corresponding CP. In example 32, which may also include one or more of the examples described herein, the GBBR comprises a second GBBR part comprising RS pairs that satisfy MRTD less than the corresponding CP.

In example 33, which may also include one or more of the examples described herein, the configuration information includes an instruction to perform a MRTD measurement.

The examples discussed above also extend to method, computer-readable medium, and means-plus-function claims and implementations, an of which may include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A user device (UE), comprising:
a memory; and
one or more processors configured to, when executing instructions stored in the memory, cause the UE to:
receive, from a base station operating as a transmission and reception point (TRP), configuration information for performing group-based beam reporting (GBBR);
determine, based on the configuration information a maximum receive timing difference (MRTD) based on a plurality of reference signals (RS), each RS of the plurality of RS being received from a different TRP; and
communicate, to the base station, the MRTD in accordance with performance of the GBBR.

2. The UE of claim 1, wherein the GBBR comprises one or more pairs of RS identifiers, each RS identifier of the one or more pairs of RS identifiers corresponding to a RS of the plurality of RS, each of the one or more pairs of RS identifiers being identified by the UE for simultaneous reception.

3. The UE of claim 2, wherein the GBBR further comprises a MRTD measurement associated with each of the one or more pairs of RS identifiers.

4. The UE of claim 3, wherein the MRTD measurement comprises a determination of whether MRTD is greater or less than a corresponding cycle prefix (CP).

5. The UE of claim 4, wherein the GBBR comprises a first GBBR part comprising RS pairs that satisfy MRTD greater than the corresponding CP.

6. The UE of claim 5, wherein the GBBR comprises a second GBBR part comprising RS pairs that satisfy MRTD less than the corresponding CP.

7. The UE of claim 1, wherein the configuration information includes an instruction to perform a MRTD measurement.

8. A baseband processor, comprising:
one or more processors configured to:
receive, from a base station operating as a transmission and reception point (TRP), configuration information for performing group-based beam reporting (GBBR);
determine, based on the configuration information a maximum receive timing difference (MRTD) based on a plurality of reference signals (RS), each RS of the plurality of RS being received from a different TRP; and
instruct a transceiver to transmit, to the base station, the MRTD in accordance with performance of the GBBR.

9. The baseband processor of claim 8, wherein the GBBR comprises one or more pairs of RS identifiers, each RS identifier of the one or more pairs of RS identifiers corresponding to a RS of the plurality of RS, each of the one or more pairs of RS identifiers being identified by the baseband processor for simultaneous reception.

10. The baseband processor of claim 9, wherein the GBBR further comprises a MRTD measurement associated with each of the one or more pairs of RS identifiers.

11. The baseband processor of claim 10, wherein the MRTD measurement comprises a determination of whether MRTD is greater or less than a corresponding cycle prefix (CP).

12. The baseband processor of claim 11, wherein the GBBR comprises a first GBBR part comprising RS pairs that satisfy MRTD greater than the corresponding CP.

13. The baseband processor of claim 12, wherein the GBBR comprises a second GBBR part comprising RS pairs that satisfy MRTD less than the corresponding CP.

14. The baseband processor of claim 8, wherein the configuration information includes an instruction to perform a MRTD measurement.

15. A method at a user equipment (UE), the method comprising:
receiving, from a base station operating as a transmission and reception point (TRP), configuration information for performing group-based beam reporting (GBBR);
determining, based on the configuration information a maximum receive timing difference (MRTD) based on a plurality of reference signals (RS), each RS of the plurality of RS being received from a different TRP; and
communicating, to the base station, the MRTD in accordance with performance of the GBBR.

16. The method of claim 15, wherein the GBBR comprises one or more pairs of RS identifiers, each RS identifier of the one or more pairs of RS identifiers corresponding to a RS of the plurality of RS, each of the one or more pairs of RS identifiers being identified for simultaneous reception.

17. The method of claim 16, wherein the GBBR further comprises a MRTD measurement associated with each of the one or more pairs of RS identifiers.

18. The method of claim 17, wherein the MRTD measurement comprises a determination of whether MRTD is greater or less than a corresponding cycle prefix (CP).

19. The method of claim 18, wherein the GBBR comprises a first GBBR part comprising RS pairs that satisfy MRTD greater than the corresponding CP and a second GBBR part comprising RS pairs that satisfy MRTD less than the corresponding CP.

20. The method of claim 15, wherein the configuration information includes an instruction to perform a MRTD measurement.
